(19) United States
(12) Patent Application Publication
(10) Pub. No.: US 2008/0089064 A1
(43) Pub. Date: Apr. 17, 2008

(54) LED Illuminating device

(76) Inventor: Baoliang Wang, Bladwin Park, CA (US)

Correspondence Address: Raymond Y. Chan;Suite 128, 108 N. Ynez Avenue, Monterey Park, CA, 91754, US

(21) Appl. No.: 11/583,470

(22) Filed: Oct. 17, 2006

(51) Int. Cl. F21V 21/00; H05B 33/00

(52) U.S. Cl. 362/249; 362/231; 362/368

(57) ABSTRACT

A LED illuminating device includes an illuminating unit and a shell having a top side and chamber. The illuminating unit includes a PCB supported by the shell and one or more LED modules electrically and spacedly mounted on the PCB disposed in the chamber. Each of the LED modules includes a red LED, a blue LED and a green LED which are symmetrically arranged in a triangular manner side by side. The shell is filled with transparent or translucence epoxy resin to cover the PCB, the root portions of electrical and power wires, which are electrically connected with the LEDs, and the chamber to seal the illuminating unit in the shell to form an integral body, wherein the wires are extended out from two ends of the top side of the LED illuminating device to the another neighboring LED illuminating device.

### BACKGROUND OF THE PRESENT INVENTION

1. Field of Invention

This invention relates to an illuminating device, and more particularly to a LED illuminating device.

2. Description of Related Arts

The Light Emitting Diode (LED) is an excellent luminescence power providing many advantages such as lower power consumption and convenient for use. The LED is a fine cold source that can be a monocolor LED which has been widely utilized all over the world on lights and lanterns including traffic light while the chromatic LED, such as trichromatic LED, has been used in the large screen or electronic billboard for displaying figures or words. The arranged shape of LEDs is a rectangle or mounting different shape according to different pictorial circuit board (PCB board) on the billboard, controlled by special hardware and software. The consumer can take attention to preinstall the picture on the screen. In addition, the LEDs have widely been also utilized in family and something else, such as adornment of Christmas tree, etc.

When the device including traffic light, big screen LED and electronic billboard make use of the conventional LEDs, the conventional LEDs having an electronic billboard are schemed out on the product. However, the drawbacks of the conventional LEDs are inflexibility, uncommonality and convenient limited.

Some inventions provide some LED illuminating device for solving previous problem, such as a Chinese patent CN1191641C which discloses a LED illuminating device comprising an illuminating unit having one or more LEDs and at least one LED chip mounted on a printed board, wherein the LED chip is controlled and driven by a control circuit which is mounted on the printed circuit picture in the circuit board. At least one jack is an electrode terminal of down-lead forming a hollow connecting base pin inserting at least one pylome, regarding as at least one power terminal and a control signal terminal.

The illuminating unit of the LED illuminating device comprising a plurality of LEDs having the same color and forming a LED module electrically connected in series or in parallel. Therefore when multiple colors are needed, many illuminating units should be aligned side by side in a complicated manner.

### SUMMARY OF THE PRESENT INVENTION

A main object of the invention is to provide a LED illuminating device which is adapted to generating a line of light source from a plurality of discrete points of light sources, so as to enhance the convenient of the operation of the LED illuminating device.

Another object of the present invention is to provide a LED illuminating device which is adapted to generate a different color source of light, and which is simple in structure and non-fragile, consumes less energy as compared with conventional neon lights and fluorescent lamps, and generates less heat when operating.

Another object of the present invention is to provide a LED illuminating device comprising many LED illuminating lights connected by four wires including a red wire, a green wire, a blue wire, and a power supply wire so as to optimally control every LED module by corresponding wires.

Another object of the present invention is to provide a LED illuminating device comprising a waterproof LED illuminating formed by sealed affusing transparent epoxy between the PCB board and the shell enabling the LED illuminating device to be used in a wide variety of environments and convenient installation.

Another object of the present invention is to provide a LED illuminating device which does not involve any expensive or complicated electrical or mechanical components so as to minimize the manufacturing cost and the ultimate selling price of the present invention.

In addition, another object of the present invention is to provide a LED illuminating device using single device or multi-device.

Another object of the present invention is to provide a LED illuminating device which is to be alternatives to neon lighting so as to provide many advantages such as freight cost reduction and usefulness.

Accordingly, in order to accomplish the above objects, the present invention provides a LED illuminating device, comprising

a shell having a top side and a chamber indented in the top side, defining a peripheral wall upwardly extended from a bottom wall of the chamber; and

an illuminating unit comprising a PCB supported by the shell and one or more LED modules electrically and spacedly mounted to the PCB disposed in the chamber, each of the LED modules including a red LED, a blue LED and a green LED which are symmetrically arranged in a triangular manner side by side, two terminals of the PCB being connected with root portions of the wires which includes electrical wires to electrically connect with the red, blue and green LEDs of the LED modules respectively and a power wire for connecting with a power source, wherein the shell is filled with transparent or translucence epoxy resin to cover the PCB, the root portions of electrical and power wires and the chamber to seal the illuminating unit in the shell to form an integral body, wherein the wires are extended out from two ends of the top side of the LED illuminating device to the another neighboring LED illuminating device. The LED module is adapted for accumulating the LEDs of the illuminators within the chamber, so as to merge the points of light source to form a line of source in the chamber.

Therefore, the PCB has three LED modules connected in series, wherein the LEDs having the same color. Four wires including a red wire, a green wire, a blue wire, and a power supply wire, which are welded at each of the two terminals of the illuminating unit. The red, green and blue wires are electrically connected with the red, green and blue LEDs respectively while the source power wire is electrically with the external power source.

The present invention provides many advantages such as simple frame, freight cost reduction, and lower fault, and it is convenience to operate that different color device attach to control respectively.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a LED illuminating device according to a preferred embodiment of the present invention.

FIG. 2 is a perspective view of the LED illuminating device according to the above preferred embodiment of the present invention.

FIG. 3 is a circuit diagram of the LED illuminating device according to the above preferred embodiment of the present invention.

FIG. 4 is illustrates an alternative mode of the above preferred embodiment of the present invention.

### DETAILED DESCRIPTION OF THE PREFERRED EMBODIMENT

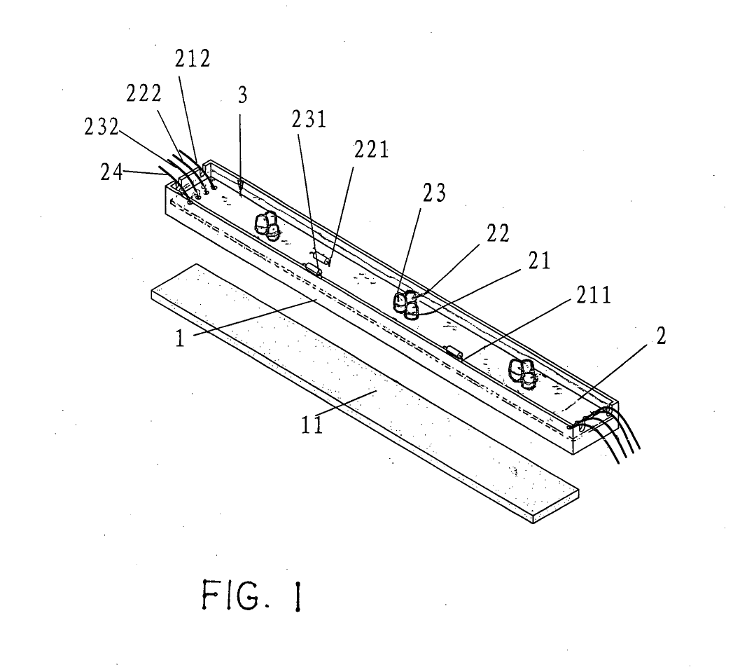

Referring to FIG. 1 to FIG. 3 of the drawings, a LED illuminating device according to a preferred embodiment of the present invention is illustrated, in which the LED illuminating device comprises a shell 1 and an illuminating unit 4.

The shell 1 of salver shape, which is made of non-fragile materials such as plastic materials, has a top side and a chamber 5 indented in the top side, defining a peripheral wall upwardly extended from a bottom wall of the chamber,

The illuminating unit 4 comprises a printed circuit board (PCB) 2 supported by the shell 1 and having one or more LEDs 21, 22 and 23 which are electrically and spacedly mounted on a PCB 2 disposed in the chamber 5. There are three LED modules each comprises a red LED 21, a green LED 22, and a blue LED 23 connected in parallel with one another. In other words, the red, blue and green LEDs 21, 22, 23 of each of the LED modules are connected with one another in serial manner. Alternatively, each LED module may include a red LED 21 and a green LED 22 connected in series while connecting a blue LED 23 in parallel. Therefore each LED module is adapted for accumulating said LEDs of the illuminators within the chamber, so as to merge points of light source to form a line of lighting in the chamber.

Each of the two terminals the PCB 2 is electrically connected by welding with four wires, generally including a red wire 212, a green wire 222, a blue wire 232, and a yellow power wire 24, wherein the red wire 212, the green wire 222 and the blue wire 232 are connected with the red LED 21, the green LED 22 and the blue LED 23 respectively while the power line 24 is adapted for connecting to a power source.

More specifically, four wires are controlled in beneficial to collocation and in different color LEDs, wherein four wires standing each of the two terminals of the PCB 2 lead-out from two ends of the top side of the shell 1.

Moreover, the red LED 21, the green LED 22 and the blue LED 23 match respectively a red resistance Rr211, a green resistance Rg221 and a blue resistance Rb231. The red LED 21, the green LED 22 and the blue LED 23 is preferably arranged in a triangular manner side by side. The shell is preferred to be made of PVC material. The height of the three-color LEDs 21, 22, 23 is designed to be higher than top of the shell 1. The back side of the shell 1 provides an adhesive layer 11 for attaching with other surfaces or that two sides of the shell 1 can be mounted in a protruding auricular mode for connecting with others.

It is worth mentioning that the LED illuminating device is constructed to form a waterproof structure by means of the affusing transparent epoxy resin 3 filled in the shell 1 to sealedly envelope the printed circuit board (PCB) 2, the connections of the root portions of the wires 212, 222, 232, 24 with the terminals of the PCB 2, and the chamber of the shell 1. In addition, the wires 212, 222, 232, 24 are permanently angled to be extended parallelly from the ends of the shell 1 to another neighboring LED illuminating devices, wherein the epoxy resin 3 substantially affirms the inclined angle of the root portions so as to ensure the wires extending transversally from the shell.

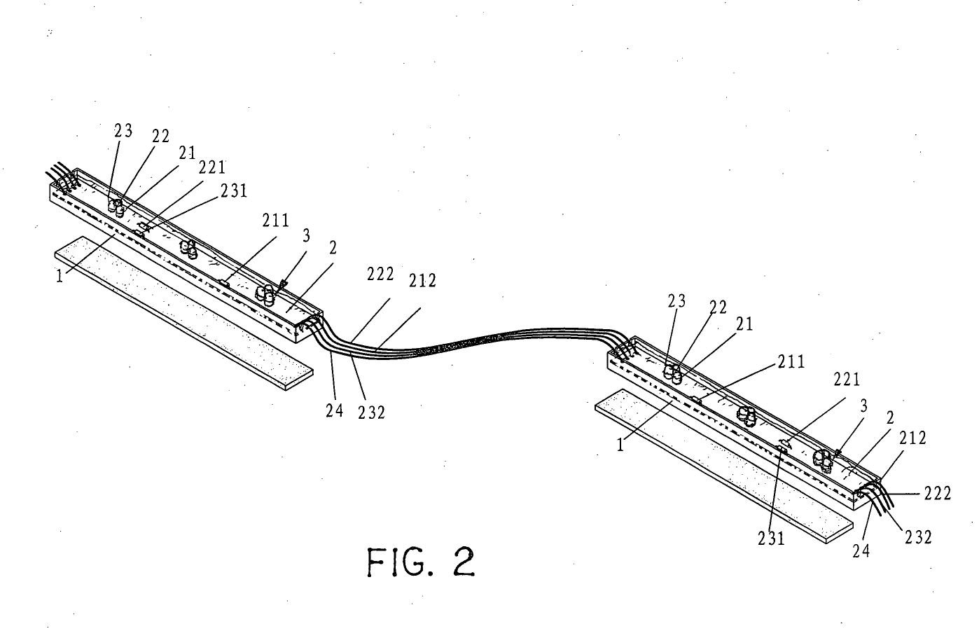

Referring to FIG. 2 of the drawings, a chain of LED illuminating devices is generally provided by simply connecting the LED illuminating devices with the wires 212, 222, 232, 24 in series. The user can cut off any set of connecting wires 212, 222, 232, 24 to obtain the desired length and number of LED illuminating devices for different applications.

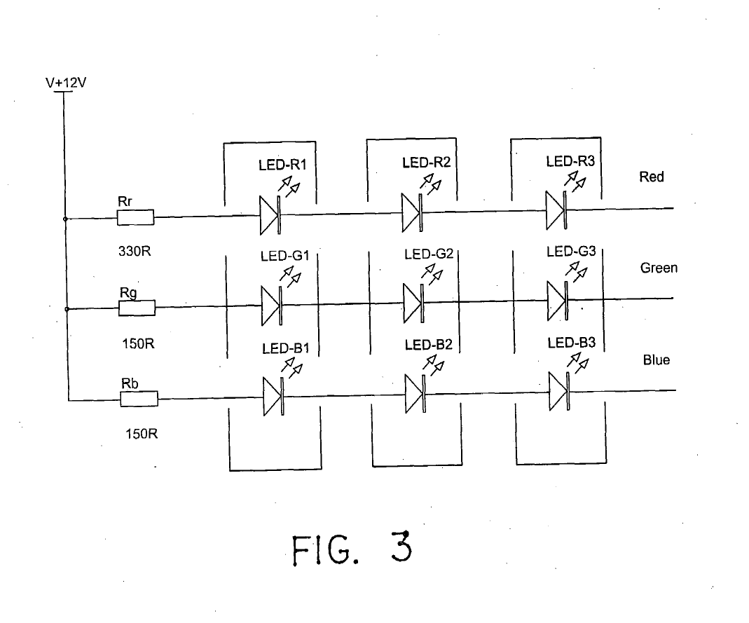

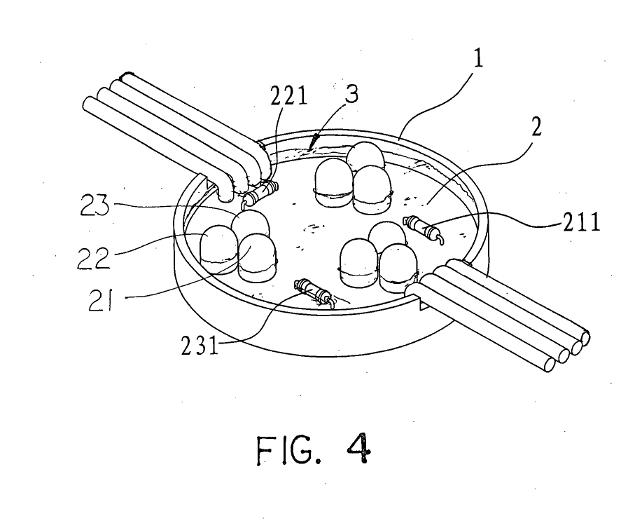

Referring to FIG. 4, an alternative mode of the LED illuminating device according to the preferred embodiment of the present invention illustrates an illuminating chain in series, wherein the three LED modules are arranged in a circular shell 1 with the same circuit arrangement as shown in FIG. 3.

One skilled in the art will understand that the embodiment of the present invention as shown in the drawings and described above is exemplary only and not intended to be limiting.

It will thus be seen that the objects of the present invention have been fully and effectively accomplished. Its embodiment have been shown and described for the purposes of illustrating the functional and structural principles of the present invention and is subject to change without departure from such principles. Therefore, this invention includes all modifications encompassed within the spirit and scope of the following claims.

What is claimed is:

1. A LED illuminating arrangement comprising a plurality of LED illuminating devices connected with wires, each of said LED illuminating devices comprising:
a shell having a top side and a chamber indented in said top side, defining a peripheral wall upwardly extended from a bottom wall of said chamber; and
an illuminating unit comprising a PCB supported by said shell and one or more LED modules electrically and spacedly mounted on said PCB disposed in said chamber, each of said LED modules including a red LED, a blue LED and a green LED which are symmetrically arranged in a triangular manner side by side, two terminals of said PCB being connected with root portions of said wires which includes electrical wires to electrically connect with said red, blue and green LEDs of said LED modules respectively and a power wire for connecting with an external power source, wherein said shell is filled with transparent or translucence epoxy resin to cover said PCB, said root portions of electrical and power wires and said chamber to seal said illuminating unit in said shell to form an integral body, wherein said wires are extended out from two ends of said top side of said LED illuminating device to said another neighboring LED illuminating device.

2. A LED illuminating arrangement, as claimed in claim 1, wherein said PCB has three LED modules connected in series.

3. A LED illuminating arrangement, as claimed in claim 1, wherein said electrical wires include a red wire, a green wire, a blue wire, weld at each of said two terminals of said PCB, wherein said red wire, said green wire and said blue wire are electrically connected with said red LED, said green LED and said blue LED of each of said LED modules respectively.

4. A LED illuminating arrangement, as claimed in claim 1, wherein said plurality of LEDs are higher than said top side of said shell.

5. A LED illuminating arrangement, as claimed in claim 2, wherein said plurality of LEDs are higher than said top side of said shell.

6. A LED illuminating arrangement, as claimed in claim 3, wherein said plurality of LEDs are higher than said top side of said shell.

7. A LED illuminating arrangement, as claimed in claim 1, wherein said wires are permanently angled to be extended parallelly from two ends of said shell to said another neighboring LED illuminating devices, wherein said epoxy resin substantially affirms an inclined angle of said root portions so as to ensure said wires extending transversally from said shell.

8. A LED illuminating arrangement, as claimed in claim 2, wherein said wires are permanently angled to be extended parallelly from two ends of said shell to said another neighboring LED illuminating devices, wherein said epoxy resin substantially affirms an inclined angle of said root portions so as to ensure said wires extending transversally from said shell.

9. A LED illuminating arrangement, as claimed in claim 3, wherein said wires are permanently angled to be extended parallelly from two ends of said shell to said another neighboring LED illuminating devices, wherein said epoxy resin substantially affirms an inclined angle of said root portions so as to ensure said wires extending transversally from said shell.

10. A LED illuminating arrangement, as claimed in claim 4, wherein said wires are permanently angled to be extended parallelly from two ends of said shell to said another neighboring LED illuminating devices, wherein said epoxy resin substantially affirms an inclined angle of said root portions so as to ensure said wires extending transversally from said shell.

11. A LED illuminating arrangement, as claimed in claim 5, wherein said wires are permanently angled to be extended parallelly from two ends of said shell to said another neighboring LED illuminating devices, wherein said epoxy resin substantially affirms an inclined angle of said root portions so as to ensure said wires extending transversally from said shell.

12. A LED illuminating arrangement, as claimed in claim 6, wherein said wires are permanently angled to be extended parallelly from two ends of said shell to said another neighboring LED illuminating devices, wherein said epoxy resin substantially affirms an inclined angle of said root portions so as to ensure said wires extending transversally from said shell.

13. A LED illuminating arrangement, as claimed in claim 1, wherein said shell has a bottom side provided with an adhesive layer for attaching to a mounting surface.

14. A LED illuminating arrangement, as claimed in claim 2, wherein said shell has a bottom side provided with an adhesive layer for attaching to a mounting surface.

15. A LED illuminating arrangement, as claimed in claim 3, wherein said shell has a bottom side provided with an adhesive layer for attaching to a mounting surface.

16. A LED illuminating arrangement, as claimed in claim 7, wherein said shell has a bottom side provided with an adhesive layer for attaching to a mounting surface.

17. A LED illuminating arrangement, as claimed in claim 8, wherein said shell has a bottom side provided with an adhesive layer for attaching to a mounting surface.

18. A LED illuminating arrangement, as claimed in claim 9, wherein said shell has a bottom side provided with an adhesive layer for attaching to a mounting surface.
